(19) United States
(12) Patent Application Publication
(10) Pub. No.: US 2026/0075599 A1
(43) Pub. Date: Mar. 12, 2026

(54) ENHANCED LOGICAL CHANNEL PRIORITIZATION FOR QUALITY OF SERVICE (QOS)

(71) Applicant: Qualcomm Incorporated, San Diego, CA (US)

(72) Inventors: Leena ZACHARIAS, San Jose, CA (US); Ashwin MADHUR COMANDUR, San Diego, CA (US); Arnaud MEYLAN, San Diego, CA (US); Sitaramanjaneyulu KANAMARLAPUDI, San Diego, CA (US); Dominique Francois BRESSANELLI, Eschborn (DE)

(21) Appl. No.: 19/324,833

(22) Filed: Sep. 10, 2025

Related U.S. Application Data
(60) Provisional application No. 63/694,119, filed on Sep. 12, 2024.

(51) Int. Cl. H04W 72/0457; H04W 24/10; H04W 28/02; H04W 72/21

(52) U.S. Cl. CPC H04W 72/0457; H04W 24/10; H04W 28/0252; H04W 72/21

(57) ABSTRACT

Methods, systems, and devices for wireless communications are described. A user equipment may allocate first communication resources to a logical channel based on a current bucket size of the logical channel and a priority associated with the logical channel, where the current bucket size is an initial positive value. The UE may decrement the current bucket size of the logical channel to a negative value that satisfies a threshold value based on a quantity of packet data units (PDUs) of the first communication resources. The UE may allocate second communication resources to the logical channel based on incrementing, at a prioritized bit rate (PBR) of the logical channel, the current bucket size from the negative value to a positive value.

### CROSS REFERENCE

The present Application for Patent claims the benefit of U.S. Provisional Patent Application No. 63/694,119 by ZACHARIAS et al., entitled “ENHANCED LOGICAL CHANNEL PRIORITIZATION FOR QUALITY OF SERVICE (QOS),” filed Sep. 12, 2024, assigned to the assignee hereof, and expressly incorporated by reference herein.

### TECHNICAL FIELD

The following relates to wireless communications, including enhanced logical channel prioritization for quality of service (QOS).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, fifth generation (5G) systems which may be referred to as New Radio (NR) systems, or sixth generation (6G) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The systems, methods, and devices of this disclosure each have several innovative aspects, no single one of which is solely responsible for the desirable attributes disclosed herein.

A method by a user equipment (UE) is described. The method may include allocating first communication resources to a logical channel based on a current bucket size of the logical channel and a priority associated with the logical channel, where the current bucket size is an initial positive value, decrementing the current bucket size of the logical channel to a negative value that satisfies a threshold value based on a quantity of packet data units (PDUs) of the first communication resources, and allocating second communication resources to the logical channel based on incrementing, at a prioritized bit rate (PBR) of the logical channel, the current bucket size from the negative value to a positive value.

A UE is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to allocate first communication resources to a logical channel based on a current bucket size of the logical channel and a priority associated with the logical channel, where the current bucket size is an initial positive value, decrement the current bucket size of the logical channel to a negative value that satisfies a threshold value based on a quantity of PDUs of the first communication resources, and allocate second communication resources to the logical channel based on incrementing, at a PBR of the logical channel, the current bucket size from the negative value to a positive value.

Another UE is described. The UE may include means for allocating first communication resources to a logical channel based on a current bucket size of the logical channel and a priority associated with the logical channel, where the current bucket size is an initial positive value, means for decrementing the current bucket size of the logical channel to a negative value that satisfies a threshold value based on a quantity of PDUs of the first communication resources, and means for allocating second communication resources to the logical channel based on incrementing, at a PBR of the logical channel, the current bucket size from the negative value to a positive value.

A non-transitory computer-readable medium storing code is described. The code may include instructions executable by one or more processors (e.g., directly, indirectly, after pre-processing, without pre-processing) to allocate first communication resources to a logical channel based on a current bucket size of the logical channel and a priority associated with the logical channel, where the current bucket size is an initial positive value, decrement the current bucket size of the logical channel to a negative value that satisfies a threshold value based on a quantity of PDUs of the first communication resources, and allocate second communication resources to the logical channel based on incrementing, at a PBR of the logical channel, the current bucket size from the negative value to a positive value.

In some examples of the method, UEs, and non-transitory computer-readable medium described herein, to decrementing the current bucket size may include operations, features, means, or instructions for setting the current bucket size to a maximum of the threshold value or the current bucket size decremented by the quantity of PDUs of the first communication resources.

Some examples of the method, UEs, and non-transitory computer-readable medium described herein may further include operations, features, means, or instructions for generating a second negative value that may be less than the threshold value based on the quantity of PDUs of the first communication resources and one or more rules and refraining from decrementing the current bucket size to the second negative value according to the threshold value.

In some examples of the method, UEs, and non-transitory computer-readable medium described herein, the threshold value may be a constant value.

In some examples of the method, UEs, and non-transitory computer-readable medium described herein, the threshold value may be based on a second quantity of PDUs.

In some examples of the method, UEs, and non-transitory computer-readable medium described herein, the threshold value may be based on a bucket size duration (BSD) of the logical channel and the PBR of the logical channel.

Some examples of the method, UEs, and non-transitory computer-readable medium described herein may further include operations, features, means, or instructions for refraining from decrementing the current bucket size by a PDU size based on the current bucket size being the negative value, where the threshold value may be based on the PDU size of the PDUs of the first communication resources.

In some examples of the method, UEs, and non-transitory computer-readable medium described herein, to allocating the second communication resources to the logical channel may include operations, features, means, or instructions for allocating the second communication resources to the logical channel based on the positive value associated with the current bucket size and the priority of the logical channel.

Some examples of the method, UEs, and non-transitory computer-readable medium described herein may further include operations, features, means, or instructions for receiving, from a network entity an indication of one or more parameters associated with the logical channel, where the priority of the logical channel, the PBR of the logical channel, a BSD of the logical channel, and the threshold value may be based on the one or more parameters.

Some examples of the method, UEs, and non-transitory computer-readable medium described herein may further include operations, features, means, or instructions for receiving a first uplink grant, where allocating the first communication resources may be based on the first uplink grant and receiving a second uplink grant, where allocating the second communication resources may be based on the second uplink grant.

A method by a UE is described. The method may include allocating first communication resources to a logical channel based on a current bucket size of the logical channel and a priority associated with the logical channel, where the current bucket size is an initial positive value, decrementing the current bucket size of the logical channel to a negative value based on a quantity of PDUs of the first communication resources, and allocating second communication resources to the logical channel prior to incrementing, at a PBR of the logical channel, the current bucket size from the negative value to a positive value.

A UE is described. The UE may include one or more memories storing processor executable code, and one or more processors coupled with the one or more memories. The one or more processors may individually or collectively be operable to execute the code to cause the UE to allocate first communication resources to a logical channel based on a current bucket size of the logical channel and a priority associated with the logical channel, where the current bucket size is an initial positive value, decrement the current bucket size of the logical channel to a negative value based on a quantity of PDUs of the first communication resources, and allocate second communication resources to the logical channel prior to incrementing, at a PBR of the logical channel, the current bucket size from the negative value to a positive value.

Another UE is described. The UE may include means for allocating first communication resources to a logical channel based on a current bucket size of the logical channel and a priority associated with the logical channel, where the current bucket size is an initial positive value, means for decrementing the current bucket size of the logical channel to a negative value based on a quantity of PDUs of the first communication resources, and means for allocating second communication resources to the logical channel prior to incrementing, at a PBR of the logical channel, the current bucket size from the negative value to a positive value.

A non-transitory computer-readable medium storing code is described. The code may include instructions executable by one or more processors to allocate first communication resources to a logical channel based on a current bucket size of the logical channel and a priority associated with the logical channel, where the current bucket size is an initial positive value, decrement the current bucket size of the logical channel to a negative value based on a quantity of PDUs of the first communication resources, and allocate second communication resources to the logical channel prior to incrementing, at a PBR of the logical channel, the current bucket size from the negative value to a positive value.

In some examples of the method, UEs, and non-transitory computer-readable medium described herein, to allocating the second communication resources may include operations, features, means, or instructions for allocating the second communication resources based on a contents of one or more PDUs of the second communication resources.

Some examples of the method, UEs, and non-transitory computer-readable medium described herein may further include operations, features, means, or instructions for refraining, from allocating third communication resources to the logical channel based on the negative value associated with the current bucket size and a second contents of one or more additional PDUs of the third communication resources.

In some examples of the method, UEs, and non-transitory computer-readable medium described herein, the contents of the one or more PDUs of the second communication resources includes a radio link control (RLC) status PDU or a RLC retransmission.

Some examples of the method, UEs, and non-transitory computer-readable medium described herein may further include operations, features, means, or instructions for initiating a timer upon decrementing the current bucket size of the logical channel to the negative value, where allocating the second communication resources may be based on an expiration of the timer.

In some examples of the method, UEs, and non-transitory computer-readable medium described herein, a duration of the timer includes a multiple of a second duration of a status prohibit timer.

Some examples of the method, UEs, and non-transitory computer-readable medium described herein may further include operations, features, means, or instructions for refraining, during a duration of the timer, from allocating third communication resources to the logical channel based on the negative value associated with the current bucket size.

Some examples of the method, UEs, and non-transitory computer-readable medium described herein may further include operations, features, means, or instructions for receiving a first uplink grant, where allocating the first communication resources may be based on the first uplink grant and receiving a second uplink grant, where allocating the second communication resources may be based on the second uplink grant.

Some examples of the method, UEs, and non-transitory computer-readable medium described herein may further include operations, features, means, or instructions for receiving, from a network entity, an indication of one or more parameters associated with the logical channel, where the priority of the logical channel, the PBR of the logical channel, a BSD of the logical channel, and the threshold value may be based on the one or more parameters.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhanced logical channel prioritization for quality of service (QOS) in accordance with one or more aspects of the present disclosure.

FIG. 2 shows an example of a wireless communications system that supports enhanced logical channel prioritization for QoS in accordance with one or more aspects of the present disclosure.

FIG. 3 shows an example of a packet data unit (PDU) session flow that supports enhanced logical channel prioritization for QoS in accordance with one or more aspects of the present disclosure.

FIG. 4 shows an example of a process flow that supports enhanced logical channel prioritization for QoS in accordance with one or more aspects of the present disclosure.

FIG. 5 shows an example of a process flow that supports enhanced logical channel prioritization for QoS in accordance with one or more aspects of the present disclosure.

FIGS. 6 and 7 show block diagrams of devices that support enhanced logical channel prioritization for QoS in accordance with one or more aspects of the present disclosure.

FIG. 8 shows a block diagram of a communications manager that supports enhanced logical channel prioritization for QoS in accordance with one or more aspects of the present disclosure.

FIG. 9 shows a diagram of a system including a device that supports enhanced logical channel prioritization for QoS in accordance with one or more aspects of the present disclosure.

FIGS. 10 through 14 show flowcharts illustrating methods that support enhanced logical channel prioritization for QoS in accordance with one or more aspects of the present disclosure.

### DETAILED DESCRIPTION

In some wireless communications systems, a user equipment (UE) may allocate communication resources to one or more logical channels. Each logical channel may correspond to a current bucket size. The UE may determine if a logical channel is allowed to be allocated communication resources based on the current bucket size of the logical channel being greater than zero. The UE may allocate communication resources to the logical channels with current bucket sizes greater than zero based on a respective priority associated with each logical channel. When a logical channel is allocated communication resources, the current bucket size of the logical channel may be decremented by a quantity of packet data units (PDUs) allocated to the logical channel. In some examples, the current bucket size may be decremented to a negative value. The UE may increment the current bucket size at a respective prioritized bit rate (PBR), but the PBR may be relatively low compared to the negative value. The logical channel may be ineligible for communication resource allocation for a relatively long time based on the relatively low PBR compared to the negative value. The logical channel may not be allocated communication resource for status PDUs or other wireless communication which may increase latency and increase connection failure.

According to techniques described herein, the UE may decrease an amount of time a logical channel corresponding to a negative current bucket size waits prior to being allocated for communication resources. In some examples, the UE may limit the current bucket size to a lower limit (e.g., threshold value). The lower limit may enable the UE to allocate communication resources to the logical channel faster. For example, a current bucket size for the logical channel may not be decreased beyond a threshold negative value, in which case the bucket size for the logical channel may be incrementally increased until the bucket size reaches a positive value in a relatively smaller period of time. In some examples, the UE may allocate communication resources to a logical channel with a current bucket size including a negative or zero value based on a contents of one or more PDUs of the logical channel or a status timer. For example, the UE may allocate communication resource to a logical channel based on the one or more PDUs including a status PDU.

Aspects of the disclosure are initially described in the context of wireless communications systems. Additional aspects of the disclosure are described in the context of a PDU session flow. Aspects of the disclosure are further illustrated by and described with reference to apparatus diagrams, system diagrams, and flowcharts that relate to enhanced logical channel prioritization for QoS.

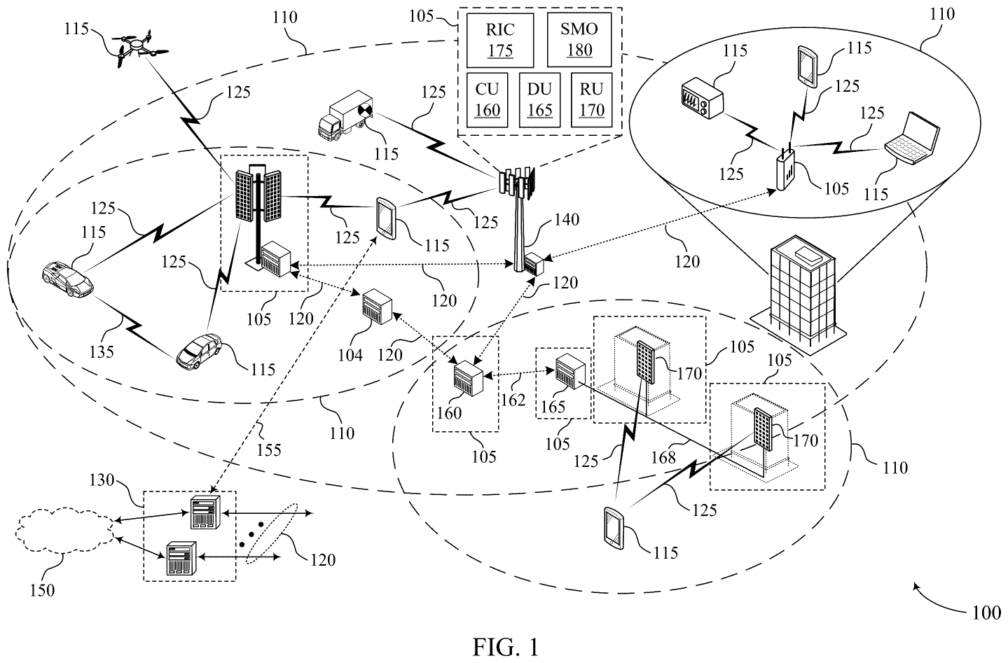

FIG. 1 shows an example of a wireless communications system 100 that supports enhanced logical channel prioritization for QoS in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support enhanced logical channel prioritization for QoS as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, the UE 115 and the network entity 105 may communicate via RLC signaling. For example, a transmitting side of an acknowledgment mode (AM) RLC entity (e.g., the UE 115 or the network entity 105) may prioritize transmission of RLC control PDUs over acknowledgment mode (AMD) PDUs. The transmitting side of the AM RLC entity may prioritize transmission of AMD PDUs containing previously transmitted RLC service data units (SDUs) or RLC SDU segments over transmission of AMD PDUs containing not previously transmitted RLC SDUs or RLC SDU segments.

In some cases, the network entity 105 may provide the UE 115 with one or more quality of service (QOS) flow descriptions associated with a PDU session at a PDU session establishment or a PDU session modification. A QoS flow description may include a QoS flow identifier (QFI). In some examples, if the flow may include a guaranteed bit rate (GBR). The QoS description may include a guaranteed flow bit rate (GFBR) for uplink, a GFBR for downlink, a maximum flow bit rate (MFBR) for uplink, a MFBR for downlink, or a averaging window for both uplink and downlink.

In some cases, the QoS flow description may include a 5G QoS (5QI) if the QFI is not the same as the 5QI of the QoS flow identified by the QFI. In some cases, the QoS flow description may include an evolved packet system (EPS) bearer identity (EBI) if the QoS flow may be mapped to an EPS bearer. If the averaging window is not included in the QoS flow description for a GBR QoS flow with a 5QI, an averaging window associated with the 5QI may apply for the averaging window. If the averaging window is not included in the QoS flow description for a GBR QOS flow with a 5QI and the 5QI is not associated with an averaging window, a configured value (e.g., two seconds) may be used as the averaging window.

According to techniques described herein, the UE 115 may decrease an amount of time a logical channel corresponding to a negative current bucket size waits prior to being allocated for communication resources. In some examples, the UE 115 may limit the current bucket size to a lower limit (e.g., threshold value). The lower limit may enable the UE 115 to allocate communication resources to the logical channel faster. In some examples, the UE 115 may allocate communication resources to a logical channel with a current bucket size including a negative or zero value based on a contents of one or more PDUs of the logical channel or a status timer. For example, the UE 115 may allocate communication resource to a logical channel based on the one or more PDUs including a status PDU.

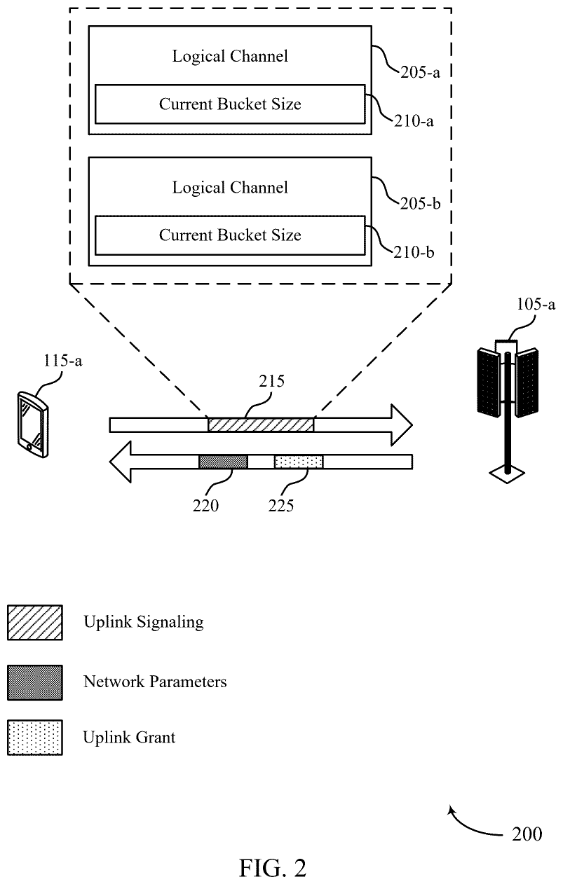

FIG. 2 shows an example of a wireless communications system 200 that supports enhanced logical channel prioritization for QoS in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. A network entity 105-a may represent an example of a network entity, such as the network entities 105 described with reference to FIG. 1. The UE 115-a may communicate to the network entity 105-a via one or more logical channels 205 (e.g., a first logical channel 205-a and a second logical channel 205-b). The UE 115-a may allocate communication resources to the one or more logical channels 205 based on a priority associated with logical channels 205 and a respective current bucket size corresponding to each logical channel 205 (e.g., a first current bucket size 210-a and a second current bucket size 210-b). The UE 115-a may transmit uplink signaling 215 based on allocating communication resources to the one or more logical channels 205.

In some wireless communications systems, the network entity 105-a may transmit an uplink grant 225 to a UE 115-a. The UE 115-a may allocate communication resources indicated by the uplink grant 225 to one or more logical channels 205. The UE 115-a may allocate communication resources in accordance with a logical channel prioritization (LCP) in a MAC layer (e.g., an LTE MAC or a NR MAC). For example, the UE 115-a may allocate PDUs in a transport block (TB) based on the LCP in the MAC layer.

The UE 115-a may allocate communication resources to the one or more logical channels 205 based on a token bucket algorithm. As part of the token bucket algorithm, each logical channel 205 may be associated with a current bucket size 210 (e.g., the first logical channel 205-a correspond to the first current bucket size 210-a and the second logical channel 205-b may correspond to the second current bucket size 210-b). The current bucket size 210 (Bj) may be an internal variable. The UE 115-a may identify logical channels 205 that are eligible to be allocated data based on the current bucket size 210 being greater than zero.

The UE 115-a may map a radio bearer to a logical channel in the MAC layer. A QoS for a radio bearer may be determined by network parameters for each logical channel 205. For example, the UE 115-a may receive network parameters 220. The UE 115-a may determine multiple QoS parameters based on the network parameters 220. In some examples, the UE 115-a may determine a priority of each logical channel 205. The priority may indicate a relative priority associated with each logical channel 205. For example, the UE 115-a may allocate communication resources to the first logical channel 205-a based on the first logical channel 205-a having a higher priority than the second logical channel 205-b. In some examples, the UE 115-a may determine a PBR of each logical channel 205 (e.g., a PBR in kilobytes per second (kBps)). The PBR may indicate the rate at which the current bucket size 210 of a logical channel 205 is increased. For example, the first current bucket size 210-a may increase at a first PBR of the first logical channel 205-a, and the second current bucket size 210-b may increase at a second PBR of the second logical channel 205-b. In some cases, the PBR may be infinity or zero. In some examples, the UE 115-a may determine a bucket size duration (BSD) of each logical channel 205. The UE 115-a may increment a current bucket size 210 at a PBR up to a threshold bucket size based on the PBR and BSD (e.g., a maximum bucket size=PBR*BSD).

When the UE 115-a receives the uplink grant 225 (e.g., at the time of the uplink grant 225), the UE 115-a may follow a three step grant allocation procedure for each of the one or more logical channels 205. In a first step, the UE 115-a may allocate communication resources to the one or more logical channels 205 with a current bucket size 210 greater than zero (Bj>0) in decreasing order of priority. In a second step, the UE 115-a may decrement one or more current bucket sizes 210 according to the resource allocation (e.g., PDU or service data units (SDU)). For example, if the first logical channel 205-a is allocated a first set of PDUs and the second logical channel 205-b is not allocated any PDUs, the first current bucket size 210-a may be decremented by a first size of the first set of PDUs, and the second current bucket size 210-b may be unchanged. If communication resources of the uplink grant 225 remain after the resource allocation, the one or more logical channels 205 may be allocated communication resources (e.g., are served) in decreasing order of priority irrespective of the current bucket sizes 210.

In an illustrative example, before the successful completion of a random access procedure initiated for dual active protocol stack (DAPS), the network entity 105-a (e.g., a target MAC entity) may not select one or more logical channels 205 corresponding to one or more non-DAPS data radio bearers (DRBs) for the uplink grant 225. The UE 115-a may receive the uplink grant 225 in a random access response or for the transmission of the message A (MSGA) payload. For example, the UE 115-a (e.g., a source MAC entity) may select one or more logical channels 205 corresponding to one or more DAPS DRBs during DAPS handover.

The UE 115-a may allocate communication resources to the one or more logical channels 205 when a new transmission is performed. The UE 115-a may select one or more logical channels 205 for the uplink grant 225. The one or more selected logical channels 205 with current bucket sizes 210 greater than zero (Bj>0) may be allocated communication resources in a decreasing priority order. For example, the UE 115-a may allocate communication resources to the first logical channel 205-a based on the first current bucket size 210-a being greater than zero (Bj>0), and the UE 115-a may not allocate communication resource to the second logical channel 205-b based on the second current bucket size 210-b being less than or equal to zero (Bj≤0). In some cases, if the PBR of the first logical channel 205-a is set to infinity, the UE 115-a may allocate communication resources for all the data that is available for transmission on the first logical channel 205-a before meeting the PBR of the lower priority logical channels 205. The UE 115-a may decrement each current bucket size 210 by a total size of MAC SDUs served to a logical channel 205 (e.g., a logical channel 205 may be referred to as a logical channel j, and the current bucket size 210 for the logical channel 205 may be referred to as Bj). For example, the second current bucket size 210-b may be decremented by a total size of MAC SDUs served to the second logical channel 205-b. In some cases, the value of a current bucket size 210 may be negative (Bj<0).

If any communication resources remain, the UE 115-a may allocate communication resources (e.g., serve) the one or more selected logical channels 205 in a strict decreasing priority order (e.g., regardless of the value of Bj) until either the data for the one or more selected logical channel 205 or the communication resources indicated by the uplink grant 225 are exhausted (e.g., whichever comes first). If multiple logical channels 205 are configured with equal priority, the UE 115-a may allocate communication resources to the multiple logical channels 205 equally.

In some cases, the UE 115-a may decrement the current bucket size 210 to a relatively large (e.g., high) negative values (e.g., when a relatively large uplink grant 225 includes multiple PDUs from a logical channel 205 when no other logical channel include data for transmission). For example, the UE 115-a may receive an indication of a quantity of communication resources (e.g., PDUs or SDUs) via the uplink grant 225. If no other logical channels 205 include data for transmission, the UE 115-a may allocate the communication resources to the first logical channel 205-a. The UE 115-a may decrement the first current bucket size 210-a by a size of the communication resources. In some cases, the UE 115-a may decrement the first current bucket size 210-a to a relatively large negative number. The first current bucket size 210-a may increment at the rate of the PBR of the first logical channel 205-a. For example, the UE 115 may increment the negative current bucket size 210 of the logical channel 205 according to the PBR, resulting in a negative bucket size for an extended period of time prior to the bucket size being incremented to a positive value. The first logical channel 205-a with a first negative current bucket size 210-a may starve until the first current bucket size 210-a is incremented by the PBR of the first logical channel 205-a to be greater than zero (e.g., until Bj grows back to greater than zero). For example, when other logical channels 205 with current bucket sizes 210 greater than zero (e.g., Bj>0) get data for transmission, the UE 115-a may allocate communication resources to the other logical channels 205 before the first logical channel 205-a based on the first current bucket size 210-a being a non-positive value. The starvation may be more severe when the PBR of the first logical channel 205-a is relatively low (e.g., 8 KBps or 16 KBps). Until the first current bucket size 210-a is greater than zero (Bj>0), traffic on the first logical channel 205-a may be gated.

Some types of communication (e.g., status PDUs and RLC retransmissions) may have a greater impact on wireless communication than others. In some examples, if status PDUs are gated off due to a negative current bucket size 210, downlink RLC window management and downlink throughput may be negatively impacted. In some examples, if RLC retransmissions are gated off, uplink window management and uplink throughput may be negatively impacted. If the first current bucket size 210-a is negative, the UE 115-a may not allocate the first logical channel 205-a communication resources for RLC status PDU or RLC retransmissions. Gating a RLC status PDU may impact the downlink RLC window management and downlink throughput. For example, the network entity 105-a may release a connection to the UE 115-a based on the UE 115-a gating an RLC status PDU. In some examples, gating RLC retransmissions may impact uplink window management and uplink throughput. In some cases, RLC status PDUs or RLC retransmissions may be prioritized within a logical channel 205 and not across the one or more logical channels 205 (e.g., according to RLC specification).

In some examples, the UE 115-a may not transmit RLC status PDUs on a secondary node bearer of a master node. The network entity 105-a may release the UE 115-a while traffic is running based on not receiving the RLC status PDUs. In some examples, the network entity 105-a may release an active connection after a 5QI switch.

According to techniques described herein, the UE 115-a may decrease an amount of time a logical channel 205 with a negative current bucket size 210 waits prior to being allocated for communication resources. In some examples, the UE 115-a may enable PBR overriding for RLC status PDUs. The UE 115-a may allocate communication resources to a logical channel 205 based on a content of the data at the logical channel 205 (e.g., even if a current bucket size of the logical channel 205 is a negative value). The UE 115-a may allocate communication resources to (e.g., allow) RLC status PDUs and RLC retransmissions irrespective of a current bucket size 210. For example, the UE 115-a may allocate communication resources to the first logical channel 205-a while the first current bucket size 210-a is a negative or zero value for first transmission types (e.g., transmission of RLC status PDUs or RLC retransmissions). Additionally, or alternatively, the UE 115-a may not allocate communication resources to the first logical channel 205-a for second transmission types.

In some examples, the UE 115-a may allocate communication resources to a logical channel 205 with a current bucket size 210 including a negative or zero value based on a timer. The UE 115-a may set a logical channel timer for each logical channel 205 to override a current bucket size 210 including a negative or zero value. For example, the UE 115-a may set a first logical channel timer for the first logical channel 205-a. After an expiration of the first logical channel timer, the UE 115-a may allocate communication resources to the first logical channel 205-a for transmission of a status PDU or RLC retransmission. In some cases, a duration of a logical channel timer may be a multiple of a status prohibit timer.

In some examples, the UE 115-a may limit a negative current bucket size 210 to a lower limit to enable for quicker recovery. The UE 115-a may limit a negative current bucket size 210 based on a threshold value (Bₗᵢₘ). For example, the UE 115-a may decrement a current bucket size 210 in accordance with Equation 1.

$${Bj}^{′} = max ( {B}_{lim} , Bj - S ) \qquad ( 1 )$$

In this example, the current bucket size 210 (Bj′) is based on a maximum of the threshold value (Bₗᵢₘ) and a previous current bucket size 210 (Bj) decremented by a size of the communication resources (e.g., PDUs or SDUs) allocated to a logical channel 205 (S).

In some examples, the threshold value may be a constant value (e.g., Bₗᵢₘ=−B, where B is constant). In some examples, the threshold may be based on a constant quantity of packets. The UE 115-a may stop decrementing the current bucket size 210 after the threshold quantity of packets (e.g., PDUs). In some examples, the threshold value may be based on a multiple of the threshold bucket size (e.g., Bₗᵢₘ=−N*BSD*PBR, where N≥1). The UE 115-a may stop decrementing the current bucket size 210 after the current bucket size 210 satisfies a threshold of N buckets negative. In some examples, the threshold value may be based on a PDU packet size. The UE 115-a may stop decrementing the current bucket size 210 at the end of a current PDU (e.g., after the allocation started with Bj>0). The threshold value (e.g., a lowest possible value) of the current bucket size 210 may be a largest IP packet size (e.g., Bₗᵢₘ=−max IP Size). For example, the UE 115-a may not decrement the current bucket size more than the largest IP packet size. In some cases, a largest IP packet size may be 1500 bytes.

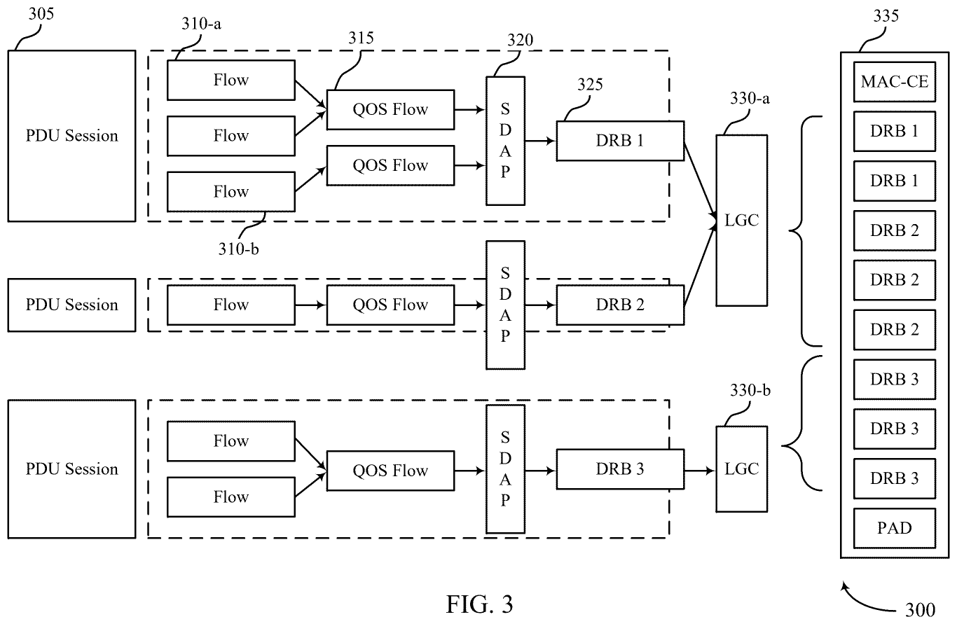

FIG. 3 shows an example of a PDU session flow 300 that supports enhanced logical channel prioritization for QoS in accordance with one or more aspects of the present disclosure. In some examples, PDU session flow 300 may implement aspects of wireless communications system 100 and wireless communications system 200. For example, the PDU session flow 300 may be implemented by a UE 115 as described with reference to FIGS. 1 and 2.

The PDU traffic at the UE 115 may include one or more PDU sessions 305. A PDU session 305 may include one or more flows 310 (e.g., app flows). A flow 310-a may be associated with a first QoS flow 315, and a flow 310-b may be associated with a second QoS flow 315. Both the flow 310-a and the flow 310-b may be associated with the same SDAP 320. Both the flow 310-a and the flow 310-b may be associated with the same DRB. The PDU session 305 may be associated with a logical channel 330-a (e.g., logical channel group (LCG)). The logical channel 330-a and a logical channel 330-b may correspond to a respective logical channel priority. The UE 115 may encode data from one or more DRB 325 in an encoded MAC TB 335 based on the logical channel priority and logical channel rules. For example, the UE 115 may allocate communication resources to the logical channel 330-a and the logical channel 330-b based on a respective current bucket size and a respective priority, as described with reference to FIG. 2. The UE 115 may transmit the encoded MAC TB 335 to the network entity 105-a.

According to techniques described herein, the UE 115 may decrease an amount of time an logical channel 330 corresponding to a negative current bucket size waits prior to being allocating for communication resources. In some examples, the UE 115 may limit the current bucket size to a lower limit (e.g., threshold value). The lower limit may enable the UE 115 to allocate communication resources to the logical channel 330 faster. In some examples, the UE 115 may allocate communication resources to a logical channel 330 with a current bucket size including a negative or zero value based on a contents of one or more PDUs of the logical channel 330 or a status timer. For example, the UE 115 may allocate communication resource to a logical channel 330 based on the one or more PDUs including a status PDU.

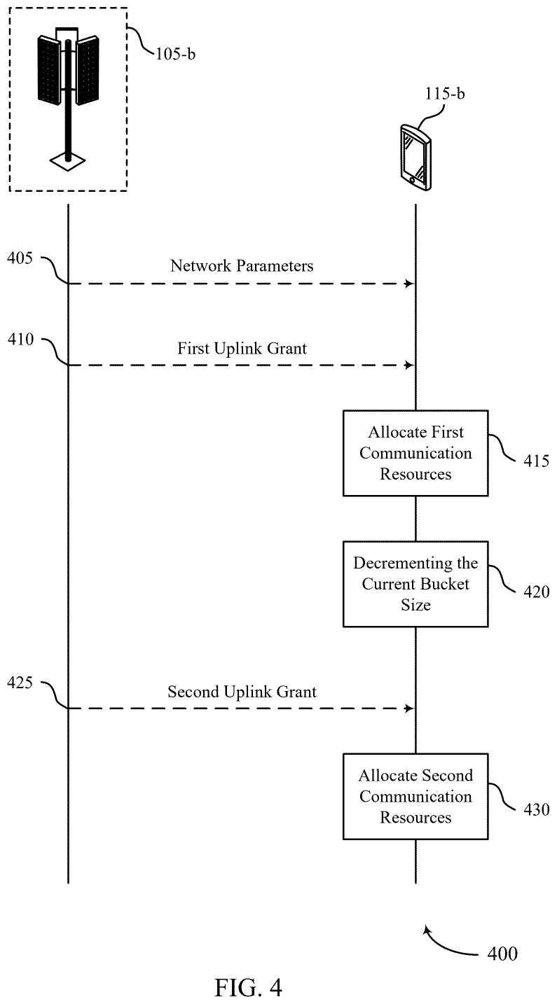

FIG. 4 shows an example of a process flow 400 that supports enhanced logical channel prioritization for QoS in accordance with one or more aspects of the present disclosure. In some examples, process flow 400 may implement aspects of, or be implemented by aspects of, the wireless communications system 100, the wireless communications system 200, or the PDU session flow 300. For example, the process flow 400 may include a network entity 105-b and a UE 115-b which may be examples of corresponding devices described with reference to FIGS. 1-3. The UE 115-b may limit the current bucket size to a lower limit (e.g., threshold value). The lower limit may enable the UE to allocate communication resources to the logical channel faster.

At 405, the UE 115-b may receive, from the network entity 105-b, an indication of one or more parameters associated with the logical channel. A priority of a logical channel, a PBR of the logical channel, a BSD of the logical channel, the threshold value, or any combination thereof may be based on (e.g., or indicated by) the one or more parameters. For example, the network entity 105-b may transmit control signaling which may include one or more parameters. In some examples, the control signaling may include an indication of the threshold value.

At 410, the UE 115-b may receive a first uplink grant, where allocating first communication resources may be based on the first uplink grant.

At 415, the UE 115-b may allocate the first communication resources to the logical channel based on a current bucket size of the logical channel and the priority associated with the logical channel. The current bucket size may be an initial positive value.

At 420, the UE 115-b may decrement the current bucket size of the logical channel to a negative value that satisfies a threshold value based on a quantity of PDUs of the first communication resources. In some cases, the threshold value may be a constant value. In some cases, the threshold value may be based on a second quantity of PDUs. In some cases, the threshold value may be based on the BSD of the logical channel and the PBR of the logical channel. In some cases, the UE 115-b may refrain from decrementing the current bucket size by a PDU size based on the current bucket size being the negative value. The threshold value may be based on the PDU size of the PDUs of the first communication resources.

In some cases, the UE 115-b may set the current bucket size to a maximum of the threshold value or the current bucket size decremented by the quantity of PDUS of the first communication resources. In some cases, the UE 115-b may generate a second negative value that is less than the threshold value based on the quantity of PDUs of the first communication resources and one or more rules. The UE 115-b may refrain from decrementing the current bucket size to the second negative value according to the threshold value.

At 425, the UE 115-b may receive a second uplink grant, where allocating second communication resources may be based on the second uplink grant.

At 430, the UE 115-b may allocating second communication resources to the logical channel based on incrementing, at the PBR of the logical channel, the current bucket size from the negative value to a positive value. In some cases, the UE 115-b may allocate the second communication resources to the logical channel based on the positive value associated with the current bucket size and the priority of the logical channel.

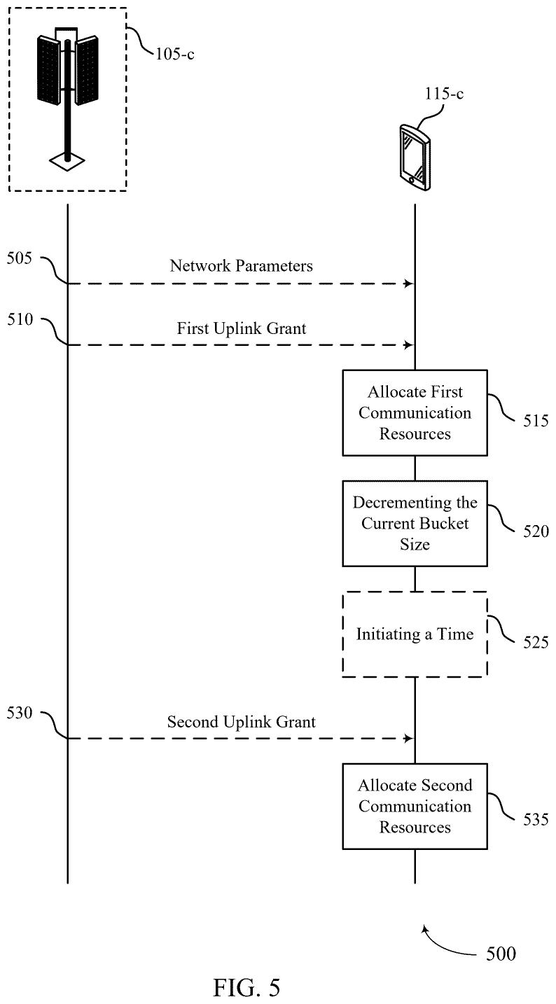

FIG. 5 shows an example of a process flow 500 that supports enhanced logical channel prioritization for QoS in accordance with one or more aspects of the present disclosure. In some examples, process flow 500 may implement aspects of, or be implemented by aspects of, the wireless communications system 100, the wireless communications system 200, the PDU session flow 300, or the process flow 400. For example, the process flow 400 may include a network entity 105-c and a UE 115-c which may be examples of corresponding devices described with reference to FIGS. 1-4. The UE 115-b may allocate communication resources to a logical channel with a negative current bucket size based on a contents of one or more PDUs of the logical channel or a status timer.

At 505, the UE 115-c may receive, from the network entity 105-c, an indication of one or more parameters associated with the logical channel. A priority of the logical channel, a PBR of the logical channel, a BSD of the logical channel, and the threshold value may be based on the one or more parameters.

At 510, the UE 115-c may receive a first uplink grant, where allocating the first communication resources may be based on the first uplink grant.

At 515, the UE 115-c may allocate first communication resources to a logical channel based on a current bucket size of the logical channel and a priority associated with the logical channel. The current bucket size may be an initial positive value.

At 520, the UE 115-c may decrement the current bucket size of the logical channel to a negative value based on a quantity of PDUs of the first communication resources.

At 525, the UE 115-c may initiate a timer upon (e.g., based on) decrementing the current bucket size of the logical channel to the negative value, where allocating the second communication resources may be based on an expiration of the timer. A duration of the timer may include a multiple of a second duration of a status prohibit timer. The UE 115-c may refrain, during a duration of the timer, from allocating third communication resources to the logical channel based on the negative value associated with the current bucket size.

At 530, the UE 115-c may receiving a second uplink grant, where allocating the second communication resources may be based on the second uplink grant.

At 535, the UE 115-c may allocate second communication resources to the logical channel prior to incrementing, at the PBR of the logical channel, the current bucket size from the negative value to a positive value. In some cases, allocating the second communication resources may be based on a contents of one or more PDUs of the second communication resources. The contents of the one or more PDUs of the second communication resources may include an RLC status PDU or an RLC retransmission.

The UE 115-c may refraining, from allocating third communication resources to the logical channel based on the negative value associated with the current bucket size and a second contents of one or more additional PDUs of the third communication resources (e.g., the one or more additional PDUs may not include an RLC status PDU or an RLC retransmission).

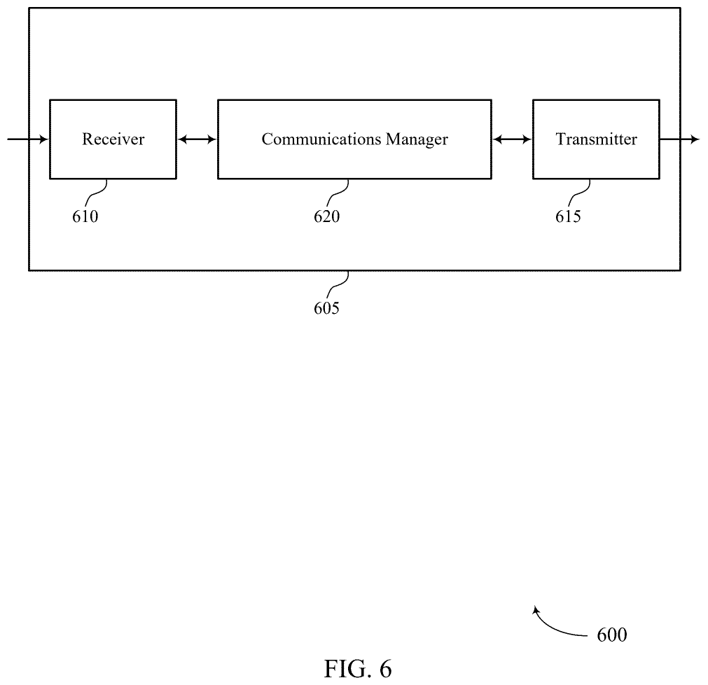

FIG. 6 shows a block diagram 600 of a device 605 that supports enhanced logical channel prioritization for QoS in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhanced logical channel prioritization for QoS). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhanced logical channel prioritization for QoS). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of enhanced logical channel prioritization for QoS as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for allocating first communication resources to a logical channel based on a current bucket size of the logical channel and a priority associated with the logical channel, where the current bucket size is an initial positive value. The communications manager 620 is capable of, configured to, or operable to support a means for decrementing the current bucket size of the logical channel to a negative value that satisfies a threshold value based on a quantity of PDUs of the first communication resources. The communications manager 620 is capable of, configured to, or operable to support a means for allocating second communication resources to the logical channel based on incrementing, at a PBR of the logical channel, the current bucket size from the negative value to a positive value.

Additionally, or alternatively, the communications manager 620 may support wireless communications in accordance with examples as disclosed herein. For example, the communications manager 620 is capable of, configured to, or operable to support a means for allocating first communication resources to a logical channel based on a current bucket size of the logical channel and a priority associated with the logical channel, where the current bucket size is an initial positive value. The communications manager 620 is capable of, configured to, or operable to support a means for decrementing the current bucket size of the logical channel to a negative value based on a quantity of PDUs of the first communication resources. The communications manager 620 is capable of, configured to, or operable to support a means for allocating second communication resources to the logical channel prior to incrementing, at a PBR of the logical channel, the current bucket size from the negative value to a positive value.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

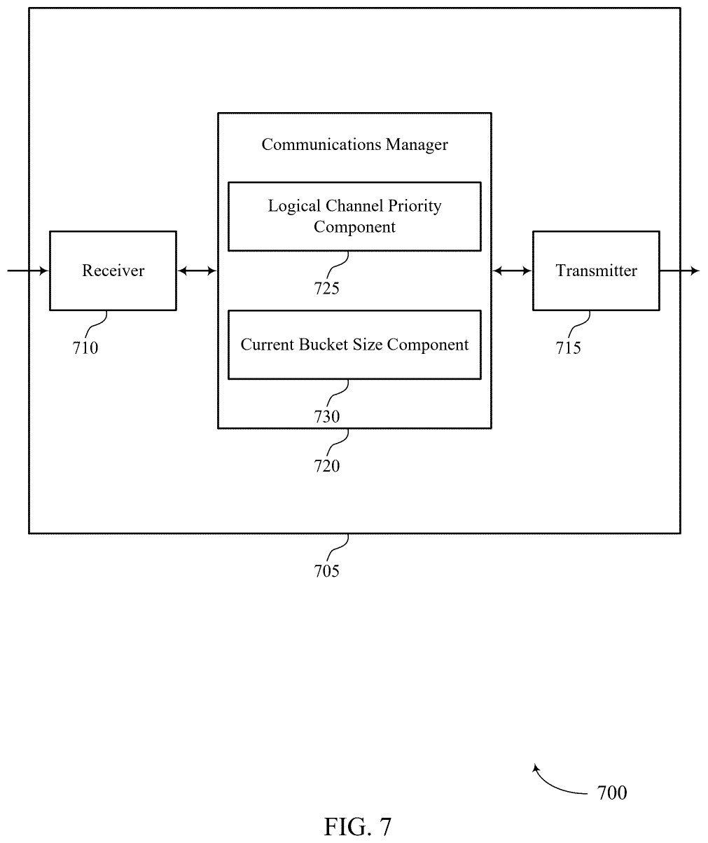

FIG. 7 shows a block diagram 700 of a device 705 that supports enhanced logical channel prioritization for QoS in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to enhanced logical channel prioritization for QoS). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to enhanced logical channel prioritization for QoS). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of enhanced logical channel prioritization for QoS as described herein. For example, the communications manager 720 may include a logical channel priority component 725, a current bucket size component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The logical channel priority component 725 is capable of, configured to, or operable to support a means for allocating first communication resources to a logical channel based on a current bucket size of the logical channel and a priority associated with the logical channel, where the current bucket size is an initial positive value. The current bucket size component 730 is capable of, configured to, or operable to support a means for decrementing the current bucket size of the logical channel to a negative value that satisfies a threshold value based on a quantity of PDUs of the first communication resources. The logical channel priority component 725 is capable of, configured to, or operable to support a means for allocating second communication resources to the logical channel based on incrementing, at a PBR of the logical channel, the current bucket size from the negative value to a positive value.

Additionally, or alternatively, the communications manager 720 may support wireless communications in accordance with examples as disclosed herein. The logical channel priority component 725 is capable of, configured to, or operable to support a means for allocating first communication resources to a logical channel based on a current bucket size of the logical channel and a priority associated with the logical channel, where the current bucket size is an initial positive value. The current bucket size component 730 is capable of, configured to, or operable to support a means for decrementing the current bucket size of the logical channel to a negative value based on a quantity of PDUs of the first communication resources. The logical channel priority component 725 is capable of, configured to, or operable to support a means for allocating second communication resources to the logical channel prior to incrementing, at a PBR of the logical channel, the current bucket size from the negative value to a positive value.

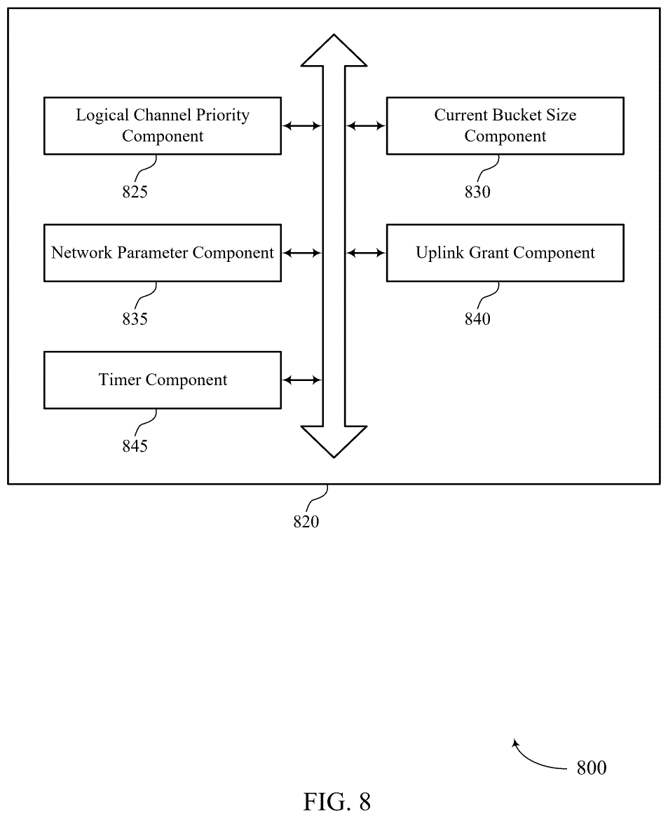

FIG. 8 shows a block diagram 800 of a communications manager 820 that supports enhanced logical channel prioritization for QoS in accordance with one or more aspects of the present disclosure. The communications manager 820 may be an example of aspects of a communications manager 620, a communications manager 720, or both, as described herein. The communications manager 820, or various components thereof, may be an example of means for performing various aspects of enhanced logical channel prioritization for QoS as described herein. For example, the communications manager 820 may include a logical channel priority component 825, a current bucket size component 830, a network parameter component 835, an uplink grant component 840, a timer component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The logical channel priority component 825 is capable of, configured to, or operable to support a means for allocating first communication resources to a logical channel based on a current bucket size of the logical channel and a priority associated with the logical channel, where the current bucket size is an initial positive value. The current bucket size component 830 is capable of, configured to, or operable to support a means for decrementing the current bucket size of the logical channel to a negative value that satisfies a threshold value based on a quantity of PDUs of the first communication resources. In some examples, the logical channel priority component 825 is capable of, configured to, or operable to support a means for allocating second communication resources to the logical channel based on incrementing, at a PBR of the logical channel, the current bucket size from the negative value to a positive value.

In some examples, to support decrementing the current bucket size, the current bucket size component 830 is capable of, configured to, or operable to support a means for setting the current bucket size to a maximum of the threshold value or the current bucket size decremented by the quantity of PDUs of the first communication resources.

In some examples, the current bucket size component 830 is capable of, configured to, or operable to support a means for generating a second negative value that is less than the threshold value based on the quantity of PDUs of the first communication resources and one or more rules. In some examples, the current bucket size component 830 is capable of, configured to, or operable to support a means for refraining from decrementing the current bucket size to the second negative value according to the threshold value.

In some examples, the threshold value is a constant value.

In some examples, the threshold value is based on a second quantity of PDUs.

In some examples, the threshold value is based on a BSD of the logical channel and the PBR of the logical channel.

In some examples, the current bucket size component 830 is capable of, configured to, or operable to support a means for refraining from decrementing the current bucket size by a PDU size based on the current bucket size being the negative value, where the threshold value is based on the PDU size of the PDUs of the first communication resources.

In some examples, to support allocating the second communication resources to the logical channel, the logical channel priority component 825 is capable of, configured to, or operable to support a means for allocating the second communication resources to the logical channel based on the positive value associated with the current bucket size and the priority of the logical channel.

In some examples, the network parameter component 835 is capable of, configured to, or operable to support a means for receiving, from a network entity, an indication of one or more parameters associated with the logical channel, where the priority of the logical channel, the PBR of the logical channel, a BSD of the logical channel, and the threshold value are based on the one or more parameters.

In some examples, the uplink grant component 840 is capable of, configured to, or operable to support a means for receiving a first uplink grant, where allocating the first communication resources is based on the first uplink grant. In some examples, the uplink grant component 840 is capable of, configured to, or operable to support a means for receiving a second uplink grant, where allocating the second communication resources is based on the second uplink grant.

Additionally, or alternatively, the communications manager 820 may support wireless communications in accordance with examples as disclosed herein. In some examples, the logical channel priority component 825 is capable of, configured to, or operable to support a means for allocating first communication resources to a logical channel based on a current bucket size of the logical channel and a priority associated with the logical channel, where the current bucket size is an initial positive value. In some examples, the current bucket size component 830 is capable of, configured to, or operable to support a means for decrementing the current bucket size of the logical channel to a negative value based on a quantity of PDUs of the first communication resources. In some examples, the logical channel priority component 825 is capable of, configured to, or operable to support a means for allocating second communication resources to the logical channel prior to incrementing, at a PBR of the logical channel, the current bucket size from the negative value to a positive value.

In some examples, to support allocating the second communication resources, the logical channel priority component 825 is capable of, configured to, or operable to support a means for allocating the second communication resources based on a contents of one or more PDUs of the second communication resources.

In some examples, the logical channel priority component 825 is capable of, configured to, or operable to support a means for refraining, from allocating third communication resources to the logical channel based on the negative value associated with the current bucket size and a second contents of one or more additional PDUs of the third communication resources.

In some examples, the contents of the one or more PDUs of the second communication resources includes a RLC status PDU or a RLC retransmission.

In some examples, the timer component 845 is capable of, configured to, or operable to support a means for initiating a timer upon decrementing the current bucket size of the logical channel to the negative value, where allocating the second communication resources is based on an expiration of the timer.

In some examples, a duration of the timer includes a multiple of a second duration of a status prohibit timer.

In some examples, the logical channel priority component 825 is capable of, configured to, or operable to support a means for refraining, during a duration of the timer, from allocating third communication resources to the logical channel based on the negative value associated with the current bucket size.

In some examples, the uplink grant component 840 is capable of, configured to, or operable to support a means for receiving a first uplink grant, where allocating the first communication resources is based on the first uplink grant. In some examples, the uplink grant component 840 is capable of, configured to, or operable to support a means for receiving a second uplink grant, where allocating the second communication resources is based on the second uplink grant.

In some examples, the network parameter component 835 is capable of, configured to, or operable to support a means for receiving, from a network entity, an indication of one or more parameters associated with the logical channel, where the priority of the logical channel, the PBR of the logical channel, and a BSD of the logical channel are based on the one or more parameters.

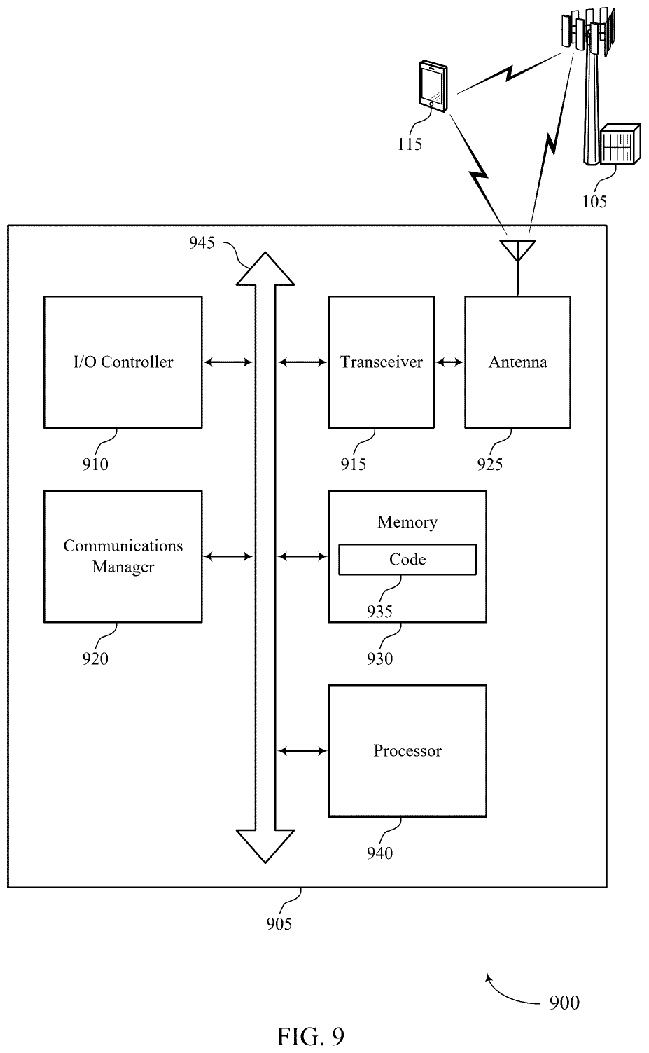

FIG. 9 shows a diagram of a system 900 including a device 905 that supports enhanced logical channel prioritization for QoS in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting enhanced logical channel prioritization for QoS). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for allocating first communication resources to a logical channel based on a current bucket size of the logical channel and a priority associated with the logical channel, where the current bucket size is an initial positive value. The communications manager 920 is capable of, configured to, or operable to support a means for decrementing the current bucket size of the logical channel to a negative value that satisfies a threshold value based on a quantity of PDUs of the first communication resources. The communications manager 920 is capable of, configured to, or operable to support a means for allocating second communication resources to the logical channel based on incrementing, at a PBR of the logical channel, the current bucket size from the negative value to a positive value.

Additionally, or alternatively, the communications manager 920 may support wireless communications in accordance with examples as disclosed herein. For example, the communications manager 920 is capable of, configured to, or operable to support a means for allocating first communication resources to a logical channel based on a current bucket size of the logical channel and a priority associated with the logical channel, where the current bucket size is an initial positive value. The communications manager 920 is capable of, configured to, or operable to support a means for decrementing the current bucket size of the logical channel to a negative value based on a quantity of PDUs of the first communication resources. The communications manager 920 is capable of, configured to, or operable to support a means for allocating second communication resources to the logical channel prior to incrementing, at a PBR of the logical channel, the current bucket size from the negative value to a positive value.

By including or configuring the communications manager 920 in accordance with examples as described herein, the device 905 may support techniques for improved communication reliability, reduced latency, more efficient utilization of communication resources, or improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of enhanced logical channel prioritization for QoS as described herein, or the at least one processor 940 and the at least one memory 930 may be otherwise configured to, individually or collectively, perform or support such operations.

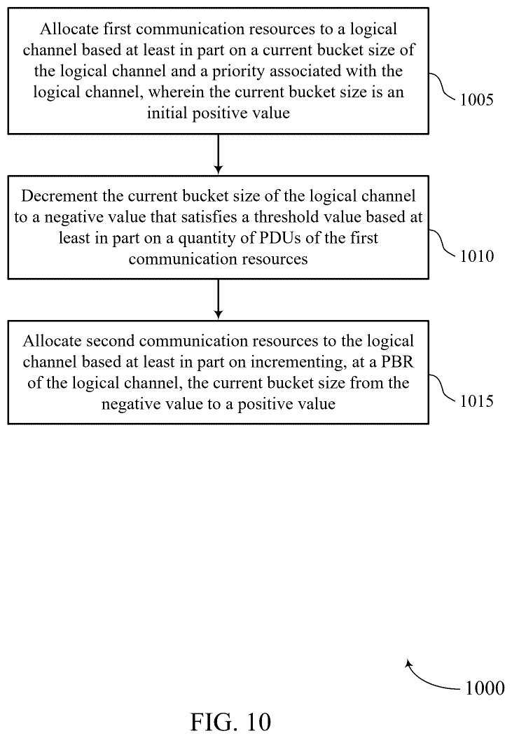

FIG. 10 shows a flowchart illustrating a method 1000 that supports enhanced logical channel prioritization for QoS in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include allocating first communication resources to a logical channel based at least in part on a current bucket size of the logical channel and a priority associated with the logical channel, wherein the current bucket size is an initial positive value. The operations of 1005 may be performed in accordance with examples as disclosed herein. In some examples, aspects of the operations of 1005 may be performed by a logical channel priority component 825 as described with reference to FIG. 8.

At 1010, the method may include decrementing the current bucket size of the logical channel to a negative value that satisfies a threshold value based at least in part on a quantity of PDUs of the first communication resources. The operations of 1010 may be performed in accordance with examples as disclosed herein. In some examples, aspects of the operations of 1010 may be performed by a current bucket size component 830 as described with reference to FIG. 8.

At 1015, the method may include allocating second communication resources to the logical channel based at least in part on incrementing, at a PBR of the logical channel, the current bucket size from the negative value to a positive value. The operations of 1015 may be performed in accordance with examples as disclosed herein. In some examples, aspects of the operations of 1015 may be performed by a logical channel priority component 825 as described with reference to FIG. 8.

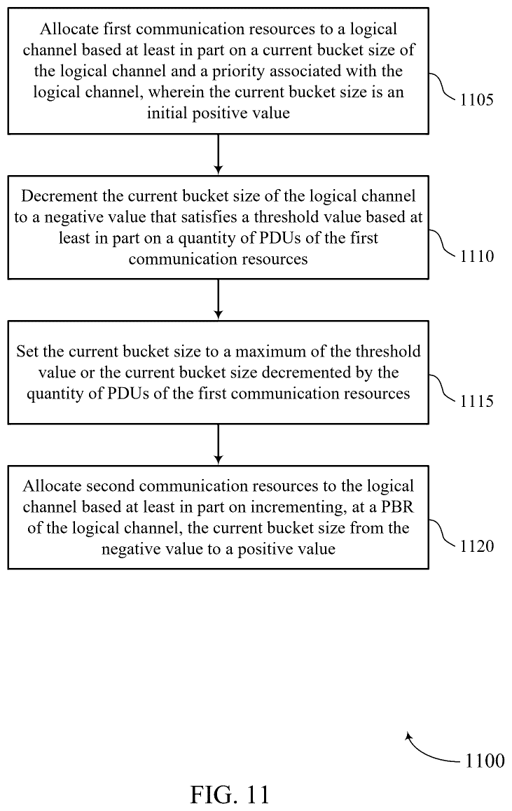

FIG. 11 shows a flowchart illustrating a method 1100 that supports enhanced logical channel prioritization for QoS in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include allocating first communication resources to a logical channel based at least in part on a current bucket size of the logical channel and a priority associated with the logical channel, wherein the current bucket size is an initial positive value. The operations of 1105 may be performed in accordance with examples as disclosed herein. In some examples, aspects of the operations of 1105 may be performed by a logical channel priority component 825 as described with reference to FIG. 8.

At 1110, the method may include decrementing the current bucket size of the logical channel to a negative value that satisfies a threshold value based at least in part on a quantity of PDUs of the first communication resources. The operations of 1110 may be performed in accordance with examples as disclosed herein. In some examples, aspects of the operations of 1110 may be performed by a current bucket size component 830 as described with reference to FIG. 8.

At 1115, the method may include setting the current bucket size to a maximum of the threshold value or the current bucket size decremented by the quantity of PDUs of the first communication resources. The operations of 1115 may be performed in accordance with examples as disclosed herein. In some examples, aspects of the operations of 1115 may be performed by a current bucket size component 830 as described with reference to FIG. 8.

At 1120, the method may include allocating second communication resources to the logical channel based at least in part on incrementing, at a PBR of the logical channel, the current bucket size from the negative value to a positive value. The operations of 1120 may be performed in accordance with examples as disclosed herein. In some examples, aspects of the operations of 1120 may be performed by a logical channel priority component 825 as described with reference to FIG. 8.

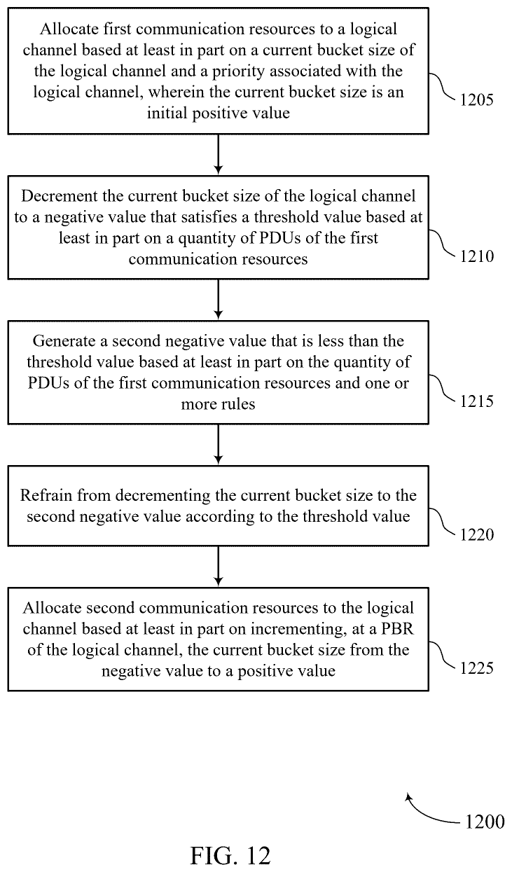

FIG. 12 shows a flowchart illustrating a method 1200 that supports enhanced logical channel prioritization for QoS in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include allocating first communication resources to a logical channel based at least in part on a current bucket size of the logical channel and a priority associated with the logical channel, wherein the current bucket size is an initial positive value. The operations of 1205 may be performed in accordance with examples as disclosed herein. In some examples, aspects of the operations of 1205 may be performed by a logical channel priority component 825 as described with reference to FIG. 8.

At 1210, the method may include decrementing the current bucket size of the logical channel to a negative value that satisfies a threshold value based at least in part on a quantity of PDUs of the first communication resources. The operations of 1210 may be performed in accordance with examples as disclosed herein. In some examples, aspects of the operations of 1210 may be performed by a current bucket size component 830 as described with reference to FIG. 8.

At 1215, the method may include generating a second negative value that is less than the threshold value based at least in part on the quantity of PDUs of the first communication resources and one or more rules. The operations of 1215 may be performed in accordance with examples as disclosed herein. In some examples, aspects of the operations of 1215 may be performed by a current bucket size component 830 as described with reference to FIG. 8.

At 1220, the method may include refraining from decrementing the current bucket size to the second negative value according to the threshold value. The operations of 1220 may be performed in accordance with examples as disclosed herein. In some examples, aspects of the operations of 1220 may be performed by a current bucket size component 830 as described with reference to FIG. 8.

At 1225, the method may include allocating second communication resources to the logical channel based at least in part on incrementing, at a PBR of the logical channel, the current bucket size from the negative value to a positive value. The operations of 1225 may be performed in accordance with examples as disclosed herein. In some examples, aspects of the operations of 1225 may be performed by a logical channel priority component 825 as described with reference to FIG. 8.

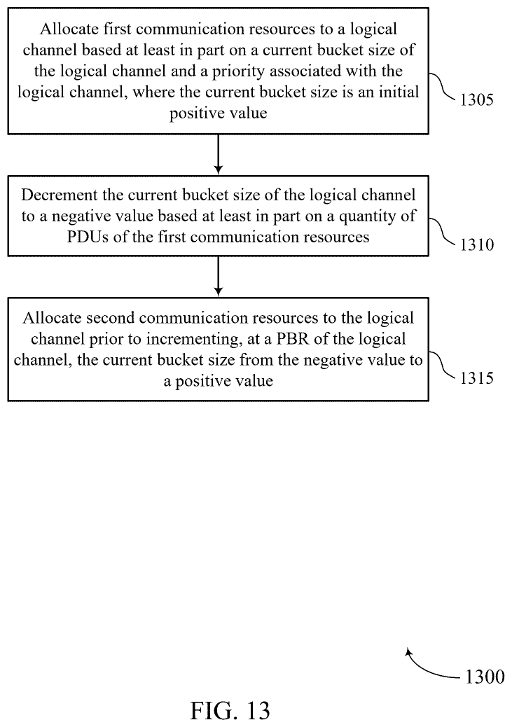

FIG. 13 shows a flowchart illustrating a method 1300 that supports enhanced logical channel prioritization for QoS in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include allocating first communication resources to a logical channel based at least in part on a current bucket size of the logical channel and a priority associated with the logical channel, wherein the current bucket size is an initial positive value. The operations of 1305 may be performed in accordance with examples as disclosed herein. In some examples, aspects of the operations of 1305 may be performed by a logical channel priority component 825 as described with reference to FIG. 8.

At 1310, the method may include decrementing the current bucket size of the logical channel to a negative value based at least in part on a quantity of PDUs of the first communication resources. The operations of 1310 may be performed in accordance with examples as disclosed herein. In some examples, aspects of the operations of 1310 may be performed by a current bucket size component 830 as described with reference to FIG. 8.

At 1315, the method may include allocating second communication resources to the logical channel prior to incrementing, at a PBR of the logical channel, the current bucket size from the negative value to a positive value. The operations of 1315 may be performed in accordance with examples as disclosed herein. In some examples, aspects of the operations of 1315 may be performed by a logical channel priority component 825 as described with reference to FIG. 8.

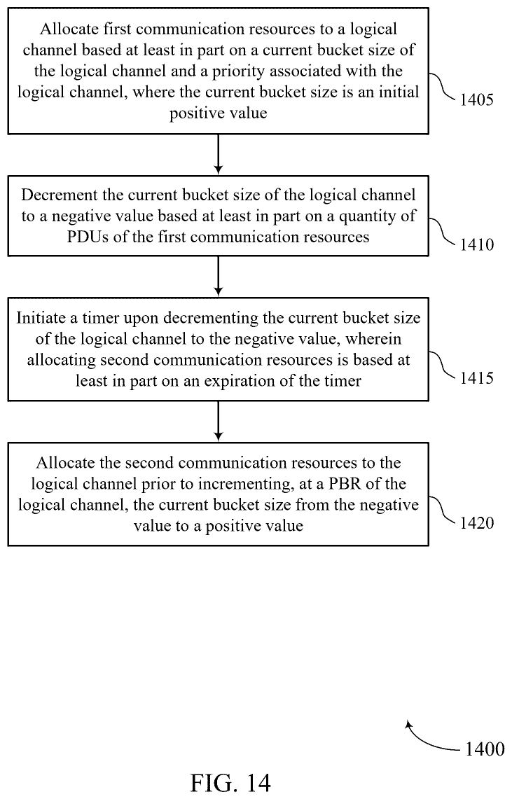

FIG. 14 shows a flowchart illustrating a method 1400 that supports enhanced logical channel prioritization for QoS in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include allocating first communication resources to a logical channel based at least in part on a current bucket size of the logical channel and a priority associated with the logical channel, wherein the current bucket size is an initial positive value. The operations of 1405 may be performed in accordance with examples as disclosed herein. In some examples, aspects of the operations of 1405 may be performed by a logical channel priority component 825 as described with reference to FIG. 8.

At 1410, the method may include decrementing the current bucket size of the logical channel to a negative value based at least in part on a quantity of PDUs of the first communication resources. The operations of 1410 may be performed in accordance with examples as disclosed herein. In some examples, aspects of the operations of 1410 may be performed by a current bucket size component 830 as described with reference to FIG. 8.

At 1415, the method may include initiating a timer upon decrementing the current bucket size of the logical channel to the negative value, wherein allocating second communication resources is based at least in part on an expiration of the timer. The operations of 1415 may be performed in accordance with examples as disclosed herein. In some examples, aspects of the operations of 1415 may be performed by a timer component 845 as described with reference to FIG. 8.

At 1420, the method may include allocating the second communication resources to the logical channel prior to incrementing, at a PBR of the logical channel, the current bucket size from the negative value to a positive value. The operations of 1420 may be performed in accordance with examples as disclosed herein. In some examples, aspects of the operations of 1420 may be performed by a logical channel priority component 825 as described with reference to FIG. 8.

The following provides an overview of aspects of the present disclosure:
Aspect 1: A method by a UE, comprising: allocating first communication resources to a logical channel based at least in part on a current bucket size of the logical channel and a priority associated with the logical channel, wherein the current bucket size is an initial positive value; decrementing the current bucket size of the logical channel to a negative value that satisfies a threshold value based at least in part on a quantity of PDUs of the first communication resources; and allocating second communication resources to the logical channel based at least in part on incrementing, at a PBR of the logical channel, the current bucket size from the negative value to a positive value.
Aspect 2: The method of aspect 1, wherein to decrementing the current bucket size further comprises: setting the current bucket size to a maximum of the threshold value or the current bucket size decremented by the quantity of PDUs of the first communication resources.
Aspect 3: The method of any of aspects 1 through 2, further comprising: generating a second negative value that is less than the threshold value based at least in part on the quantity of PDUs of the first communication resources and one or more rules; and refraining from decrementing the current bucket size to the second negative value according to the threshold value.
Aspect 4: The method of any of aspects 1 through 3, wherein the threshold value is a constant value.
Aspect 5: The method of any of aspects 1 through 3, wherein the threshold value is based at least in part on a second quantity of PDUs.
Aspect 6: The method of any of aspects 1 through 3, wherein the threshold value is based at least in part on a BSD of the logical channel and the PBR of the logical channel.
Aspect 7: The method of any of aspects 1 through 6, further comprising: refraining from decrementing the current bucket size by a PDU size based at least in part on the current bucket size being the negative value, wherein the threshold value is based at least in part on the PDU size of the PDUs of the first communication resources.
Aspect 8: The method of aspect 1, wherein to allocating the second communication resources to the logical channel further comprises: allocating the second communication resources to the logical channel based at least in part on the positive value associated with the current bucket size and the priority of the logical channel.
Aspect 9: The method of any of aspects 1 through 8, further comprising: receiving, from a network entity an indication of one or more parameters associated with the logical channel, wherein the priority of the logical channel, the PBR of the logical channel, a BSD of the logical channel, and the threshold value are based at least in part on the one or more parameters.
Aspect 10: The method of any of aspects 1 through 9, further comprising: receiving a first uplink grant, wherein allocating the first communication resources is based at least in part on the first uplink grant; and receiving a second uplink grant, wherein allocating the second communication resources is based at least in part on the second uplink grant.
Aspect 11: A method by a UE, comprising: allocating first communication resources to a logical channel based at least in part on a current bucket size of the logical channel and a priority associated with the logical channel, wherein the current bucket size is an initial positive value; decrementing the current bucket size of the logical channel to a negative value based at least in part on a quantity of PDUs of the first communication resources; and allocating second communication resources to the logical channel prior to incrementing, at a PBR of the logical channel, the current bucket size from the negative value to a positive value.
Aspect 12: The method of aspect 11, wherein to allocating the second communication resources further comprises: allocating the second communication resources based at least in part on a contents of one or more PDUs of the second communication resources.
Aspect 13: The method of aspect 12, further comprising: refraining, from allocating third communication resources to the logical channel based at least in part on the negative value associated with the current bucket size and a second contents of one or more additional PDUs of the third communication resources.
Aspect 14: The method of any of aspects 12 through 13, wherein the contents of the one or more PDUs of the second communication resources comprises a RLC status PDU or a RLC retransmission.
Aspect 15: The method of aspect 11, further comprising: initiating a timer upon decrementing the current bucket size of the logical channel to the negative value, wherein allocating the second communication resources is based at least in part on an expiration of the timer.
Aspect 16: The method of aspect 15, wherein a duration of the timer comprises a multiple of a second duration of a status prohibit timer.
Aspect 17: The method of any of aspects 15 through 16, further comprising: refraining, during a duration of the timer, from allocating third communication resources to the logical channel based at least in part on the negative value associated with the current bucket size.
Aspect 18: The method of any of aspects 11 through 17, further comprising: receiving a first uplink grant, wherein allocating the first communication resources is based at least in part on the first uplink grant; and receiving a second uplink grant, wherein allocating the second communication resources is based at least in part on the second uplink grant.
Aspect 19: The method of any of aspects 11 through 18, further comprising: receiving, from a network entity, an indication of one or more parameters associated with the logical channel, wherein the priority of the logical channel, the PBR of the logical channel, a BSD of the logical channel, and the threshold value are based at least in part on the one or more parameters.
Aspect 20: A UE comprising one or more memories storing processor-executable code, and one or more processors coupled with the one or more memories and individually or collectively operable to execute the code to cause the UE to perform a method of any of aspects 1 through 10.
Aspect 21: A UE comprising at least one means for performing a method of any of aspects 1 through 10.
Aspect 22: A non-transitory computer-readable medium storing code the code comprising instructions executable by one or more processors to perform a method of any of aspects 1 through 10.
Aspect 23: A UE comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 11 through 19.
Aspect 24: A UE comprising at least one means for performing a method of any of aspects 11 through 19.
Aspect 25: A non-transitory computer-readable medium storing code the code comprising instructions executable by one or more processors (e.g., directly, indirectly, after pre-processing, without pre-processing) to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase-change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
allocate first communication resources to a logical channel based at least in part on a current bucket size of the logical channel and a priority associated with the logical channel, wherein the current bucket size is an initial positive value;
decrement the current bucket size of the logical channel to a negative value that satisfies a threshold value based at least in part on a quantity of packet data units of the first communication resources; and
allocate second communication resources to the logical channel based at least in part on incrementing, at a prioritized bit rate of the logical channel, the current bucket size from the negative value to a positive value.

2. The UE of claim 1, wherein, to decrement the current bucket size, the one or more processors are individually or collectively further operable to execute the code to cause the UE to:
set the current bucket size to a maximum of the threshold value or the current bucket size decremented by the quantity of packet data units of the first communication resources.

3. The UE of claim 1, wherein the one or more processors are individually or collectively further operable to execute the code to cause the UE to:
generate a second negative value that is less than the threshold value based at least in part on the quantity of packet data units of the first communication resources and one or more rules; and
refrain from decrementing the current bucket size to the second negative value according to the threshold value.

4. The UE of claim 1, wherein the threshold value is a constant value.

5. The UE of claim 1, wherein the threshold value is based at least in part on a second quantity of packet data units.

6. The UE of claim 1, wherein the threshold value is based at least in part on a bucket size duration of the logical channel and the prioritized bit rate of the logical channel.

7. The UE of claim 1, wherein the one or more processors are individually or collectively further operable to execute the code to cause the UE to:
refrain from decrementing the current bucket size by a packet data unit size based at least in part on the current bucket size being the negative value, wherein the threshold value is based at least in part on the packet data unit size of the packet data units of the first communication resources.

8. The UE of claim 1, wherein, to allocate the second communication resources to the logical channel, the one or more processors are individually or collectively further operable to execute the code to cause the UE to:
allocate the second communication resources to the logical channel based at least in part on the positive value associated with the current bucket size and the priority of the logical channel.

9. The UE of claim 1, wherein the one or more processors are individually or collectively further operable to execute the code to cause the UE to:
receive, from a network entity an indication of one or more parameters associated with the logical channel, wherein the priority of the logical channel, the prioritized bit rate of the logical channel, a bucket size duration of the logical channel, and the threshold value are based at least in part on the one or more parameters.

10. The UE of claim 1, wherein the one or more processors are individually or collectively further operable to execute the code to cause the UE to:
receive a first uplink grant, wherein allocating the first communication resources is based at least in part on the first uplink grant; and
receive a second uplink grant, wherein allocating the second communication resources is based at least in part on the second uplink grant.

11. A user equipment (UE), comprising:
one or more memories storing processor-executable code; and
one or more processors coupled with the one or more memories and individually or collectively operable to execute the code to cause the UE to:
allocate first communication resources to a logical channel based at least in part on a current bucket size of the logical channel and a priority associated with the logical channel, wherein the current bucket size is an initial positive value;
decrement the current bucket size of the logical channel to a negative value based at least in part on a quantity of packet data units of the first communication resources; and
allocate second communication resources to the logical channel prior to incrementing, at a prioritized bit rate of the logical channel, the current bucket size from the negative value to a positive value.

12. The UE of claim 11, wherein, to allocate the second communication resources, the one or more processors are individually or collectively further operable to execute the code to cause the UE to:
allocate the second communication resources based at least in part on a contents of one or more packet data units of the second communication resources.

13. The UE of claim 12, wherein the one or more processors are individually or collectively further operable to execute the code to cause the UE to:
refrain, from allocating third communication resources to the logical channel based at least in part on the negative value associated with the current bucket size and a second contents of one or more additional packet data units of the third communication resources.

14. The UE of claim 12, wherein the contents of the one or more packet data units of the second communication resources comprises a radio link control status packet data unit or a radio link control retransmission.

15. The UE of claim 11, wherein the one or more processors are individually or collectively further operable to execute the code to cause the UE to:
initiate a timer upon decrementing the current bucket size of the logical channel to the negative value, wherein allocating the second communication resources is based at least in part on an expiration of the timer.

16. The UE of claim 15, wherein a duration of the timer comprises a multiple of a second duration of a status prohibit timer.

17. The UE of claim 15, wherein the one or more processors are individually or collectively further operable to execute the code to cause the UE to:
refrain, during a duration of the timer, from allocating third communication resources to the logical channel based at least in part on the negative value associated with the current bucket size.

18. The UE of claim 11, wherein the one or more processors are individually or collectively further operable to execute the code to cause the UE to:
receive a first uplink grant, wherein allocating the first communication resources is based at least in part on the first uplink grant; and
receive a second uplink grant, wherein allocating the second communication resources is based at least in part on the second uplink grant.

19. The UE of claim 11, wherein the one or more processors are individually or collectively further operable to execute the code to cause the UE to:
receive, from a network entity, an indication of one or more parameters associated with the logical channel, wherein the priority of the logical channel, the prioritized bit rate of the logical channel, and a bucket size duration of the logical channel are based at least in part on the one or more parameters.

20. A method for wireless communications at a user equipment (UE), comprising:
allocating first communication resources to a logical channel based at least in part on a current bucket size of the logical channel and a priority associated with the logical channel, wherein the current bucket size is an initial positive value;
decrementing the current bucket size of the logical channel to a negative value that satisfies a threshold value based at least in part on a quantity of packet data units of the first communication resources; and
allocating second communication resources to the logical channel based at least in part on incrementing, at a prioritized bit rate of the logical channel, the current bucket size from the negative value to a positive value.
